(19) United States
(12) Patent Application Publication
(10) Pub. No.: US 2006/0071639 A1
(43) Pub. Date: Apr. 6, 2006

(54) Method and circuitry for charging a capacitor to provide a high pulsed power discharge

(75) Inventors: Rens Ross, Austin, TX (US); Stephen James Schmidt, Round Rock, TX (US)

Correspondence Address: ROSS SPENCER GARSSON;WINSTEAD SECHREST & MINICK P.C., P. O. BOX 50784, DALLAS, TX, 75201, US

(73) Assignee: Nanotechnologies, Inc., Austin, TX (US)

(21) Appl. No.: 10/955,018

(22) Filed: Sep. 30, 2004

(51) Int. Cl. H02J 7/00

(52) U.S. Cl. 320/116

(57) ABSTRACT

An AC power source is coupled to a step-up transformer that provides a rectified DC output voltage to charge an intermediate capacitor. A high voltage electronic switch is turned ON and OFF by a control signal to couple and decouple the intermediate capacitor to the input of an inductor that supplies current to a capacitor bank. A switching regulator controller generates a control signal to vary the turn ON and OFF times of the electronic switch to generate a controlled current through the inductor while the voltage across the capacitor bank varies over a positive and negative voltage range during charging and discharging of the capacitor bank. The controlled current through the inductor is maintained while the capacitor bank is discharged. The value of the controlled current may be constant or varied in response to input and output voltage and current parameters.

### TECHNICAL FIELD

The present invention relates in general to high voltage and high power capacitive charging supplies with circuitry that provides short circuit protection and withstands ringing capacitive loading.

### BACKGROUND INFORMATION

To provide a high voltage, high current charging system for pulsed power applications usually entails charging a capacitor with a high voltage power supply over a relatively long time period and discharging the capacitor over a much shorter time period. The simplest circuit would entail a high constant voltage power supply with a current limiting resistor in series with the output. If a short circuit occurred across this power supply, additional circuitry would be needed to quickly disable the charging path or the current limiting resistor would have to be capable of dissipating power generated by the short circuit current until the output of the high voltage power supply is disabled. This design has very poor power efficiency and is unacceptable for high power applications where currents may range up to 1000 amperes and voltages may range up to 20,000 volts.

An improved high voltage power system for charging a capacitor bank uses SCRs to modulate the output voltage so that it generates a controlled current as the capacitor bank charges from a low voltage to full voltage. The output voltage may be controlled with circuitry on the input or output side of a transformer used to interface with the AC line voltage. Since a controlled current is used, the power system is less sensitive to sustained short circuits on the output, however, to turn OFF this type of power system requires waiting for each SCR to pass through zero current. This timescale may be too long for high power applications as the surge current that occurs while waiting for SCR turn OFF can still damage components in the power supply section. To improve the sustained short circuit response, a fast electronic switch may be added to the output which is switched OFF rapidly if a sustained short circuit condition is detected. However, such high power electronic switches may still switch too slowly to prevent the SCRs from being damaged during an unanticipated output short circuit. To remedy this situation a series inductor may be added to limit the rate of change in output current. Adding the series inductor creates additional problems of voltage spikes which may in turn damage the electronic switch if not controlled.

Prior art high voltage charging systems typically have severe limitations with regard to conditions for charging and discharging the capacitor bank. In particular, prior art charging systems typically use low power output diodes which are directly in the pulsed discharge current path if the capacitor voltage swings to the opposite polarity (rings). Depending on implementation details, this type of circuit, without additional protection circuitry, is not able to tolerate discharging the capacitor bank during charging, ringing capacitor discharges, or accidental disconnection from a capacitive load. Without protection, this type of supply is not robust. Recommended protection circuits typically involve a power wasting series resistor.

Prior art high power charging systems suffer from one or more serious shortcomings including low power efficiency with or without external short-circuit protection (which also adds complexity), significant notching of the input AC power, high cost, inability to tolerate a ringing capacitor discharge, or destruction of the supply if accidentally disconnected from the capacitive load while charging. They also typically cannot operate in a continuous charging mode because they fail to recover rapidly from short-circuit conditions and/or it is necessary to disconnect the supply from the capacitor bank before a pulsed power discharge. If the capacitor bank is used as part of a high pulsed power manufacturing process, these shortcomings significantly increase system cost, reduce reliability, and severely limit production rates.

There is, therefore, a need for a robust and economical capacitive charging power system that provides continuous charging, tolerates frequent and unexpected short circuit conditions, and rapidly recovers from short circuit conditions, while continuously regulating output current or power. Additionally, there is a need for a charging power supply that provides high power efficiency, tolerates ringing capacitor discharges, and survives accidental disconnection from the capacitive load.

### SUMMARY OF THE INVENTION

A power system is configured for charging a capacitor bank which is then discharged over a short period to provide high pulsed power (energy/unit time). The power system uses a high voltage electronic switch and an inductor with a free-wheeling diode to enable a controlled current to be continuously provided to the capacitor bank throughout the charge/discharge cycle. The power system is not disconnected from the capacitor bank during the discharge cycle and is unaffected by capacitor ringing.

In one embodiment, a step-up 3 phase 50/60 Hz transformer is used to isolate the power system from the AC line voltage, limit the maximum fault current, and filter harmonics from getting back onto the local AC power. The transformer AC output voltage is rectified to generate an unregulated DC high voltage output which is used to charge an intermediate capacitor. A fast high voltage electronic switch couples the DC high voltage output to a current regulating inductor which is in turn coupled to the capacitor bank. The current regulating inductor controls the current rise time when the electronic switch is turned ON and delivers stored energy to the capacitor bank through a free-wheeling diode when the electronic switch is turned OFF.

In one embodiment of the present invention, the capacitor bank is connected to a pair of electrodes and is used to provide a very high peak current when an arc is initiated in a gap between the two electrodes. Other impedance switched loads may also be used to discharge the capacitor which is charged with the charging system according to embodiments of the present invention.

The instantaneous current through the current regulating inductor is sensed and used to regulate the capacitor charging current between a lower level and an upper level by turning the electronic switch ON when the output current drops below the lower current level and by turning the electronic switch OFF when the output current increases above the upper current level. Since the DC high voltage is unregulated and the current is regulated using the same components needed for fast response short-circuit protection, the power system is very economical. The switching frequency for the electronic switch is determined by the time period to increase the current from the lower level to the upper level and to decrease from the upper level to the lower level. In this sense the switching frequency is “free running” without a fixed forced value.

By determining the lower and upper current levels (hysterisis band) relative to a reference set point, which may be static or time-varying, the average level of the current may be controlled to follow a desired program. For example, in one embodiment it may be desirable to control the output current to maintain a constant level. In another embodiment it may be desirable to control the capacitor bank charging current to keep the AC line input power constant. In this embodiment, the electronic switch is controlled so that the output current charging the capacitor bank is varied to keep the product of the root mean square (RMS) input current and input voltage provided by the AC source a constant value over the charging cycle. In yet another embodiment, the current charging the capacitor bank is controlled to maintain a constant instantaneous power output to the capacitor bank by decreasing the charging current as the capacitor bank voltage increases.

The current control mode selected for a particular application depends on the requirements for the application. Constant current mode minimizes the power dissipation in the power supply components averaged over a charging cycle and hence delivers the maximum average power output for a given power supply implementation. A constant RMS input power mode minimizes strain on the local AC power distribution system. This mode may be required for very high power systems or when operation in environments where large fluctuations in the local AC power voltage and load cannot be tolerated. A constant output power mode provides nearly the same benefits as the constant RMS input power mode, however the constant output power mode responds faster to changing load conditions.

Discharging the capacitor bank occurs when a load coupled across the capacitor bank is switched to a low impedance state. For example, if the capacitor bank is used to provide pulsed power to an arc initiated between two electrodes across the capacitor bank, the arc becomes the low impedance load. The low impedance of the load is a “virtual” short circuit as it is normally created on purpose. The difference between a virtual short circuit and a short circuit fault at the output is that the virtual short circuit will clear (e.g., arc extinguishes) when there is not enough current flowing between the electrodes to sustain the arc.

Since the charging current is rapidly controlled and has a predetermined maximum value, the regulating circuitry does not have to be turned OFF during a discharge cycle. If a non-clearing short circuit condition is sensed on the output, the fast electronic switch may be switched OFF. Any energy stored in the current regulating inductor continues to charge the capacitor bank through a free-wheeling diode coupled between ground and the output of the electronic switch. Action to disable current control may be taken if it is determined that a short circuit is sustained. The power system of the present invention can continue to supply controlled current to the capacitor bank even during a rapid discharge. If the charging current is not sufficient in itself to sustain an arc, as soon as the arc extinguishes, charging will immediately resume allowing for faster operation with less dead time. The electronic switch may also be turned OFF if the voltage across the capacitor bank exceeds a predetermined maximum level. Hysterisis may be employed to control when switching action is again enabled after a maximum output voltage level has been reached and the bank voltage subsequently drops due to a non-zero load impedance.

The power system of the present invention tolerates frequent and unexpected virtual short circuit conditions, rapidly recovers from short circuit conditions, and does not need to be turned OFF during normal operations when a virtual short circuit is initiated across the capacitor bank during high pulsed power discharges. These attributes result in the highest possible output duty cycle. Since the power system of the present invention uses no resistive limiting elements during normal operation, it provides high power efficiency. The power system also tolerates ringing capacitor discharges and tolerates accidental disconnections of the capacitor bank without damage. The present invention, therefore, provides a highly reliable and economical power system for charging a capacitor bank that is suitable for demanding manufacturing or industrial applications.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a circuit diagram of a power system for charging a capacitor bank used to supply energy according to embodiments of the present invention;

FIG. 2 is a circuit diagram of a device employing insulated gate bipolar transistors (IGBTs) suitable for making an electronic switch for charging the capacitor bank according to embodiments of the present invention;

FIG. 3 is a circuit diagram of a control circuit for controlling the electronic switch according to embodiments of the present invention;

FIG. 4A is a flow diagram of method steps used in a first embodiment of the present invention;

FIG. 4B is a flow diagram of additional steps used in the embodiment of FIG. 4A;

FIG. 5A is a flow diagram of method steps used in a second embodiment of the present invention;

FIG. 5B is a flow diagram of additional steps used in the embodiment of FIG. 5A; and

FIG. 6A is a flow diagram of method steps used in a third embodiment of the present invention;

FIG. 6B is a flow diagram of additional steps used in the embodiment of FIG. 6A.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing, and the like have been omitted inasmuch as such details are not necessary to obtain a complete understanding of the present invention and are within the skills of persons of ordinary skill in the relevant art.

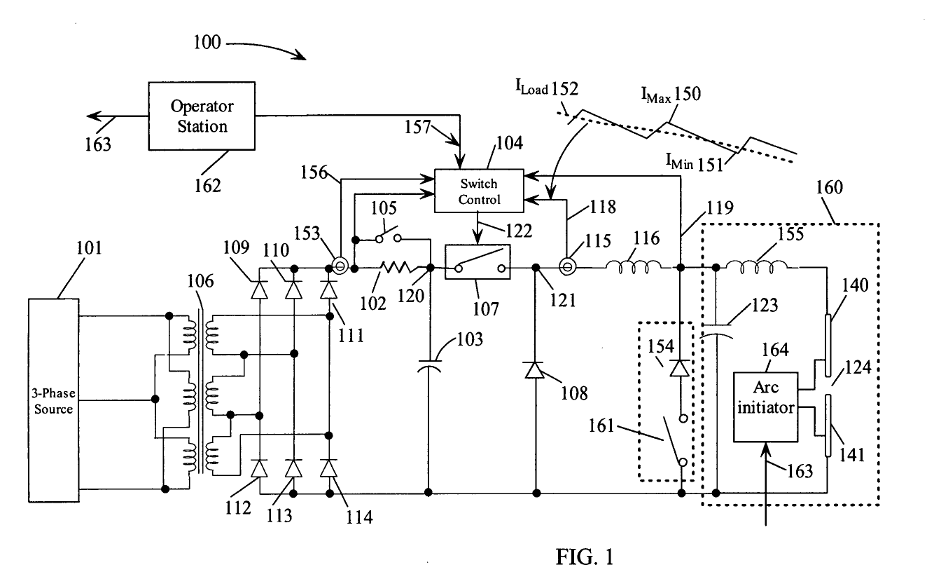

FIG. 1 is a circuit diagram of a capacitor bank charging power system 100 for an arc discharging process 160 according to embodiments of the present invention. Three phase 50/60 Hz power source 101 is coupled to the primary of a 3-phase isolation transformer 106. While it is most common to have 50/60 Hz AC line voltage available from commercial power companies, it is understood that other line voltages with other frequencies are within the scope of the present invention. Isolation transformer 106 is a step-up transformer generating the high voltage needed to provide a controlled output current (controlled current source). Diode rectifiers 109-114 form a full wave 3-phase bridge rectifier that converts the alternating current (AC) output of transformer 106 to half sine waves with an unregulated average DC value. Capacitor 103 provides intermediate energy storage. Resistor 102 is used when power is first turned ON to limit the inrush current into capacitor 103. After capacitor 103 is charged, electromechanical switch 105 (control input not shown) is closed removing resistor 102 from the circuit. High voltage electronic switch (E-switch) 107 is controlled by switch control 104 in response to the measured parameters of current (current sense 156 or 118) and voltage (input voltage 120 or output voltage 119). Control inputs 157 provide reference voltages and mode control that determine how the output current charging capacitor bank 123 is controlled. Control signals 157 may be provided via an operator station 162 either under manual control or under control of a process control program. Operator station 162 may be a hardware station or a computer terminal that controls aspects of process 160 using software routines.

Current sensor 115 senses a measure of the output current and current sensor 153 senses a measure of the input current of power system 100. Switch control 104 compares a measured current (depending on a mode control) to a high current reference level (Imax 150) and a low current reference level (Imin 151) generating control signal 122 that turns E-switch 107 ON and OFF to maintain an average current Iload 152 through inductor 116. E-switch 107 is turned ON when the reference level indicates the current through inductor 116 falls below Imin 151 and E-switch 107 is turned OFF when the reference level indicates the current through inductor 116 exceeds Imax 150. Imax 150 and Imin 151 are current increments above and below Iload 152 which is set by reference values and a mode control signal in control signals 157.

The output voltage 119 is also coupled to switch control 104. E-switch 107 may also be turned OFF if output voltage 119 is substantially equal to a predetermined maximum voltage level indicating capacitor bank 123 is fully charged. Hysteresis may be employed to ensure that output voltage 119 has to drop an incremental amount before E-switch 107 is turned back ON. In other embodiments, the input current (156), measured by current sensor 153, and the input voltage 120 are used to set the Iload 152 and thus Imax 150 and Imin 151 used to generate control signal 122. Which current and voltage signals are used to control the current charging capacitor bank 123 is determined by the mode control signals in signals 157. Free-wheeling diode 108 turns ON when E-switch 107 turns OFF to ensure the current flow through inductor 116 is continuous. When E-switch 107 is ON, the controlled current in inductor 116 charging capacitor bank 123 increases at a rate controlled by the voltage at node 121, the voltage across capacitor bank 123, and the value of inductor 116. When E-switch 107 is OFF, the stored energy in inductor 116 causes the current charging capacitor bank 123 to continue by flowing through diode 108. As the energy in inductor 116 is transferred to capacitor bank 123, the charging current will decay. On average, approximately the same current flows into capacitor bank 123 when E-switch 107 is ON or OFF.

Process 160 discharges the energy stored on capacitor bank 123 by creating a low impedance when an arc in gap 124 is initiated. An arc may be initiated using a device 164 that applies a transient high voltage across gap 124 when triggered by a control signal 163 from operator station 162. Likewise, an arc may be initiated spontaneously without a control signal 163 when conditions of gap 124 and the voltage across capacitor bank 124 are conducive to arc formation. Such conditions may occur with sufficient frequency that the power system 100 needs to “ignore” the resulting virtual short circuit condition unless there is a determination that the conduction does not terminate across gap 124 after a discharge cycle; either initiated by a controlled action or inadvertently.

When capacitor bank 123 is fully charged, a control signal 163 triggers arc initiator 164 to generate a transient voltage that initiates an arc in gap 124 between electrodes 140 and 141 starting a discharge cycle for capacitor bank 123. Inductor 155 is optionally used to control the pulsed current rise from capacitor bank 123 and it typically has significantly lower inductance than inductor 116. Inductor 116 will not allow the current from output 121 to change abruptly. When the discharge of capacitor bank 123 commences, the output voltage 119 will drop rapidly as the arc in the gap 124 between electrodes 140 and 141 is a “virtual” short circuit. If the current from output 121 is not adequate to sustain the arc, it may be continued while capacitor 123 is discharging to ensure fast recharge of capacitor bank 123 after the arc has extinguished.

If the discharge process of capacitor bank 123 is not critically damped, then the voltage on capacitor bank 123 will “ring” wherein the voltage across the capacitor bank 123 has positive and negative excursions and multiple cycles may result before all the energy is dissipated. Optional diode 154 may be added to prevent the voltage across capacitor bank 123 from going negative by more than one diode drop of diode 154. In this embodiment, since capacitor bank 123 cannot charge in the negative direction, all the energy is dissipated as current flows in one direction. If diode 154 is used, lower cost capacitors with longer life may be used as they would experience voltage of only one polarity. In other cases, it may be desirable to have the option to either allow or not allow the voltage across capacitor bank 123 to have negative excursions. Optional switch 161 would allow diode 154 to be added or removed either manually or via a control signal if it is an electromechanical switch.

If the arc in gap 124 is used as part of a manufacturing process, the frequency of discharge cycles is important. Since capacitor bank 123 is charged with a controlled current, E-switch 107 may continue operating under control of switch control 104 during a discharge cycle. This ensures that charging of capacitor bank 123 commences immediately after the arc in gap 124 extinguishes without any delay. If the voltage 119 does not start to rise after reaching a short circuit value, then additional action may be taken signaling a sustained short circuit condition wherein E-switch 107 is turned OFF and an operator is notified of the sustained short circuit condition.

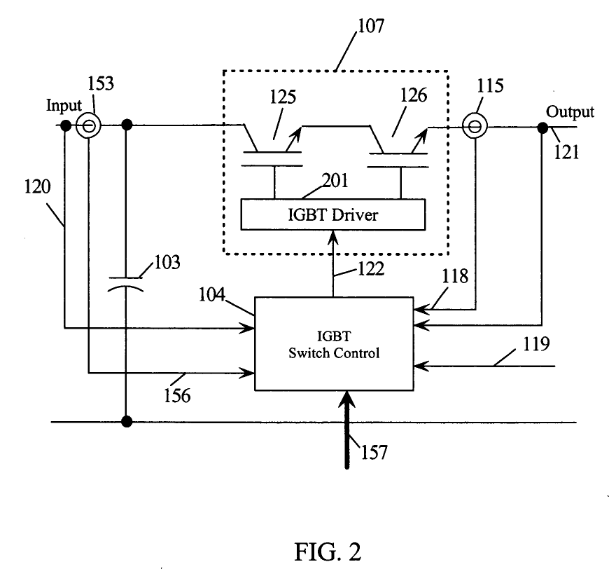

FIG. 2 is a circuit diagram of two high voltage insulated gate bipolar transistors (IGBTs) 125 and 126 suitable to configure E-switch 107. IGBTs 125 and 126 are controlled by driver circuitry 201 in response to control signal 122 generated by switch control 104. Switch control 104 uses various combinations of output current sense signal 118, input current sense signal 156, input voltage 120, and output voltage signal 119 to generate control signal 122 depending on mode and reference input signals 157.

In very high power applications, it may be desirable to present a constant load to the AC line voltage supply power to the power system of the present invention. In this case, embodiments of the present invention control E-switch 107 to vary the current to output 121 so that the input power as a one-cycle RMS product of voltage 120 and current sensed by current sensor 153 is substantially constant over a charging cycle for capacitor bank 123. In an alternate embodiment, E-switch 107 may be controlled to vary the current sourced by output 121 so that the output power is substantially constant. In this embodiment, the current as sensed by current sense 115 decreases and increases as the voltage across capacitor bank 123 (119) increases and decreases, respectively. In this manner, Iload 152 is modulated and thus Imax 150 and Imin 151 are varied to keep either the input or output power substantially constant to control the input power while providing short circuit protection. Various circuits may be employed for IGBT driver 201 that are turned ON and OFF in response to logic states of control signal 122. For example, Applied Power Systems, 124 Charlotte Ave., Hicksville, N.Y. 11801-2620 has an IGBT driver Model #AP-1318 suitable for driving IGBTs 125 and 126.

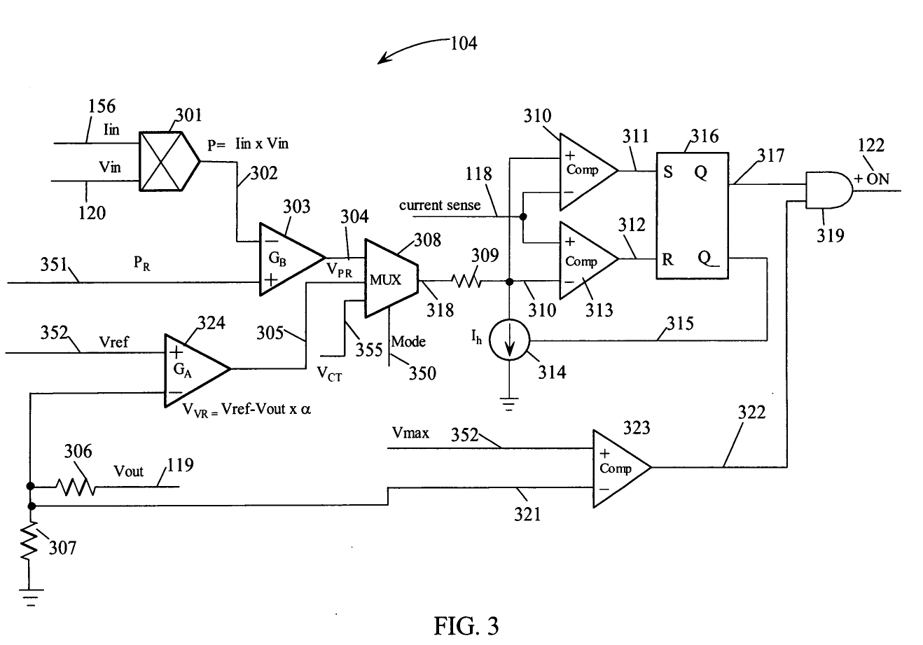

FIG. 3 is a circuit diagram of an exemplary switch control 104 suitable to control the output current (as sensed by current sensor 115) used to charge capacitor bank 123 according to embodiments of the present invention. Control signal 122 is generated by AND logic gate 319 as the logic combination of output 317 of latch 316 and comparator output 322. Output voltage 119 is divided by resistors 306 and 307 to generate a low voltage signal 321 proportional to output voltage 119. If signal 321 proportional to output voltage 119 is greater than Vmax 352, then output 322 of comparator 323 transitions to a logic zero and control signal 122 transitions to a logic zero turning OFF E-switch 107. Comparator 323 may have internal hysterisis to ensure output 119 has to decay an increment before output 322 transitions again to a logic one. If output 321 is less than Vmax 352, then the logic state of control signal 122 is determined by the latch output 317. Latch 316 is set by a logic one at set input 311 and is reset by a logic one at reset input 312. Set input 311 is a logic one when reference signal 310 is greater than output current sense 118 indicating the output current to capacitor bank 123 is below a desired value. When current sense 118 is greater than reference signal 310, set input 311 transitions to a logic zero and reset input 312 transitions to a logic one resetting latch 316, and control signal 122 transitions to a logic zero turning OFF E-switch 107. Thereby control signal 310 sets the current level at which E-switch turns OFF and ON. When latch 316 is reset, complementary output 315 transitions to a logic one turning ON gated current source 314 which causes control signal 310 to shift by a voltage increment determined by the product of the current of gated current source 314 and the value of resistor 309. In this manner, Imax 150 is the value of control signal 318 at the output of analog multiplexer (MUX) 308 and Imin 151 is the value of Imax 150 shifted lower by the voltage increment determined by the product of the current of current source 314 and the value of resistor 309. This exemplary circuitry ensures that the current ripple on the output current charging capacitor bank 123 as indicated by current sense signal 118 is an average value between Imax 150 and Imin 151. Other circuitry may be used to accomplish the same result and still be within the scope of the present invention.

Control signal 318 is selected from reference inputs V_{PR} 304, V_{VR} 305, and V_{CT} 355 in response to mode control signal 350 supplied within input signals 157. For example, mode control signal 350 may have exemplary binary encoded digital values 0-2. When mode control signal 350 has digital value 0, V_{PR} 304 is selected as control signal 318. When mode control signal 350 has digital value 1, V_{VR} 305 is selected as control signal 318. When mode control signal 350 has digital value 2, V_{CT} 355 is selected as control signal 318. V_{CT} 355 is selected when the it is desired to have the charging current a constant as determined by the value of V_{CT} 355. V_{PR} 304 is the output of differential amplifier 303 which has a gain of G_{B}. If gain G_{B} is sufficiently high, then V_{PR} 304 forces the output current to capacitor bank 123 to the value that results in the input power 302 equaling a constant value corresponding to power reference P_{R} 351. Input current 156 and input voltage 120 are multiplied by analog multiplier 301 to generate control signal 302. Analog multiplier 301 has scaling factors (not shown) that ensures the levels of P 302 and P_{R} 351 are at compatible voltage ranges.

When mode control signal 350 has digital value 1, V_{VR} 305 is selected as control signal 318. V_{VR} 305 is generated as the output of differential amplifier 324. Output voltage 119 is divided by resistors 306 and 307 to form control signal 321. When control signal 321 indicates that output voltage 119 (voltage across capacitor bank 323) is zero, then V_{VR} 305 is equal to Vref 352. Vref 352 would define the maximum value of the current allowed during a charging cycle of capacitor bank 123. As capacitor bank 123 charges, output voltage 119 rises and V_{VR} 305 is decreased. This causes the current charging capacitor bank 123 to decrease as output voltage 119 increases. Likewise, when output voltage 119 decreases, the current charging capacitor bank 123 increases. This feedback action controls the output current charging capacitor bank 123 such that the instantaneous power to capacitor bank 123 (voltage times current) is substantially constant over the charging cycle.

Control circuit 104 is an exemplary circuit and other circuit topologies may be used to generate controlled output currents according to embodiments of the present invention. For example, sensor signals 118 and 156, voltages 119 and 120, as well as mode control and references 350, 351, 352, and 355 may be digitized and inputted into a real time software controller that has a program of instructions that perform the functions of the circuitry in switch control 104 shown in FIG. 3. Such a real time software controller is within the scope of the present invention.

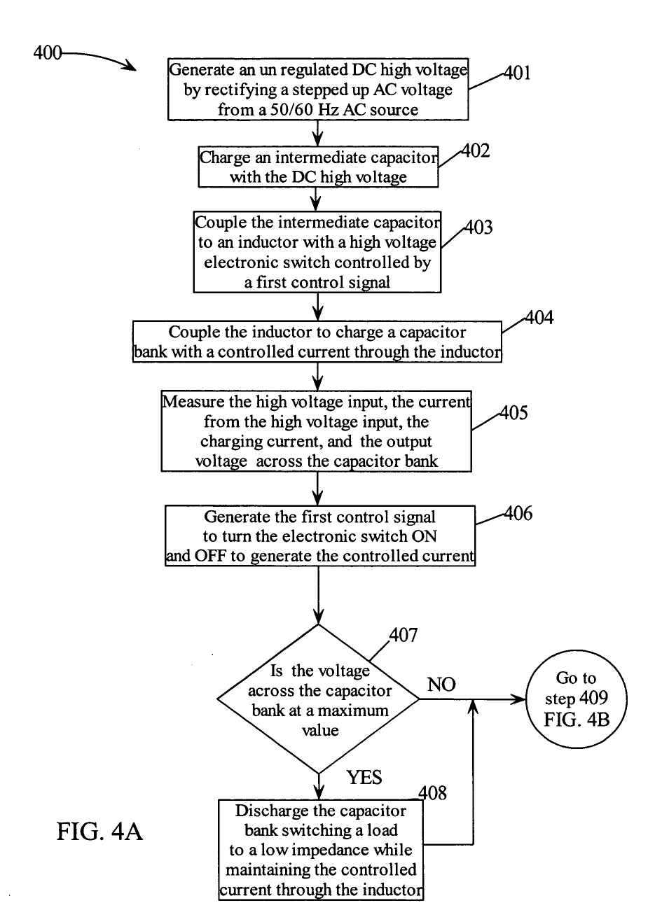

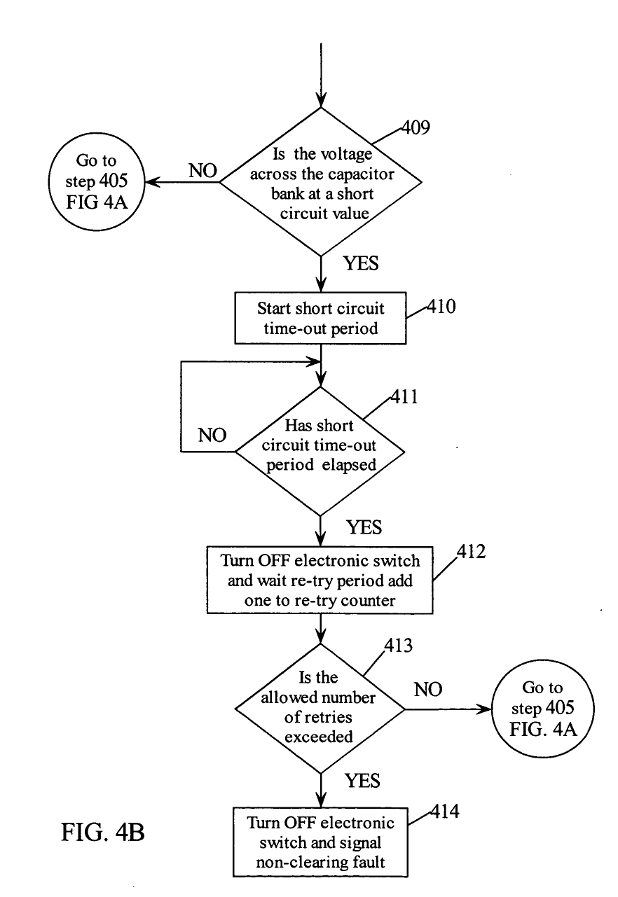

FIG. 4A is a flow diagram 400 of method steps used in an embodiment of the present invention. In step 401, a high voltage input is generated as a rectified DC voltage from a 50/60 Hz AC source. In step 402, an intermediate capacitor is charged with the high voltage input. In step 403, the intermediate capacitor is coupled to one node of an inductor with a high voltage electronic switch (E-switch) controlled by a first control signal. In step 404, the other node of the inductor is coupled to charge a capacitor bank with a controlled current by turning ON and OFF the E-switch in response to the first control signal. In step 405, the high voltage input, the current from the high voltage input (input current), the charging current and the output voltage across the capacitor bank are measured with sensors. In step 406, the first control signal is generated so that the electronic switch is turned ON and OFF thereby controlling the current charging the capacitor bank so that the product of the input current and the high voltage input is substantially constant. In step 407, a test is done to determine if the voltage across the capacitor bank has reached a maximum value. If the result of the test in step 407 is NO, then a branch is taken to step 409 of FIG. 4B continuing with additional steps. If the result of the test in step 407 is YES, then the capacitor bank may be discharged to provide pulsed power. In step 408, the capacitor bank is discharged in response to a second control signal that triggers a load coupled across the capacitor bank to switch to a low resistance. In one embodiment the load is an arc initiated in a gap between two electrodes coupled across the capacitor bank. A branch is then taken to step 409 of FIG. 4B.

FIG. 4B has additional steps of flow diagram 400 beginning at step 409. In step 409, a test is done to determine if the voltage across the capacitor bank is at a short circuit value. This condition will exist after the capacitor bank is discharged to provide controlled pulsed power, discharged inadvertently, or because a short circuit fault exists. If the voltage across the capacitor bank is not a short circuit value, then a branch is taken back to step 405 in FIG. 4A where the high voltage input, the current from the high voltage input, the charging current, and the output voltage are measured. If the voltage across the capacitor bank is a short circuit value, then in step 410 a short circuit time-out period is started if one is not already in progress. This time-out period allows time for a virtual short that is the result of an initiated arc to clear (arc naturally extinguishes when capacitor bank energy is dissipated). In step 411, a test is done to determine if the time-out period has elapsed. If the result of the test in step 411 is NO, then a branch is taken back to step 409 to determine if the capacitor voltage is still a short circuit value. If the result of the test in step 411 is YES, then in step 412 the electronic switch is turned OFF and a wait is initiated before a retry is started. A retry counter keeps track of the number of retries. In step 413, a test is done to determine if the maximum number of retries has been exceeded. If the result of the test in step 413 is NO, then a branch is taken back to step 405 where input parameters (voltages and currents) are updated. If the result of the test in step 413 is YES, then the electronic switch is gated OFF and a non-clearing short circuit fault is signaled. The method of FIGS. 4A and 4B keeps the input power from the AC source substantially constant.

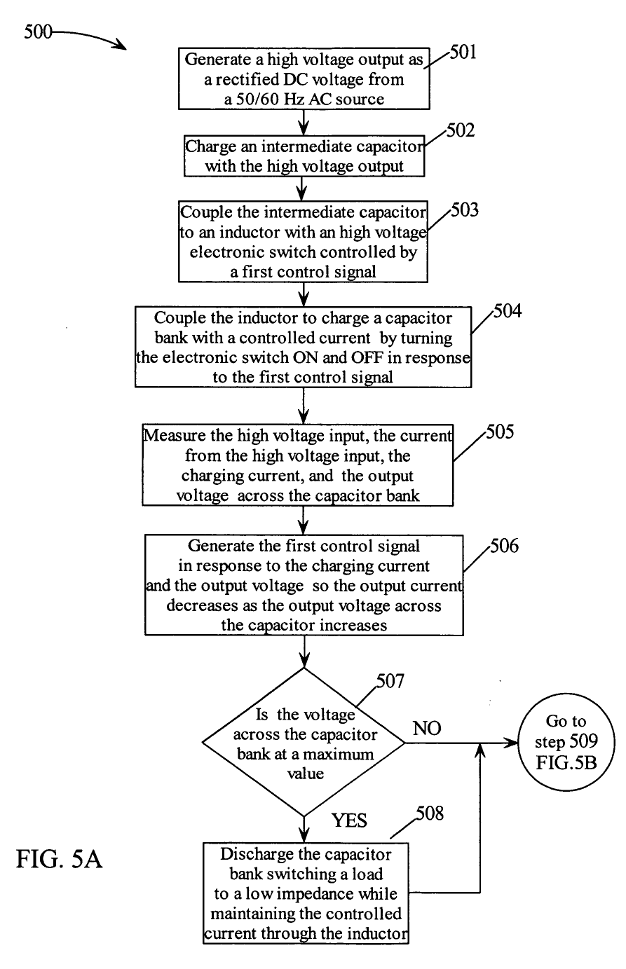

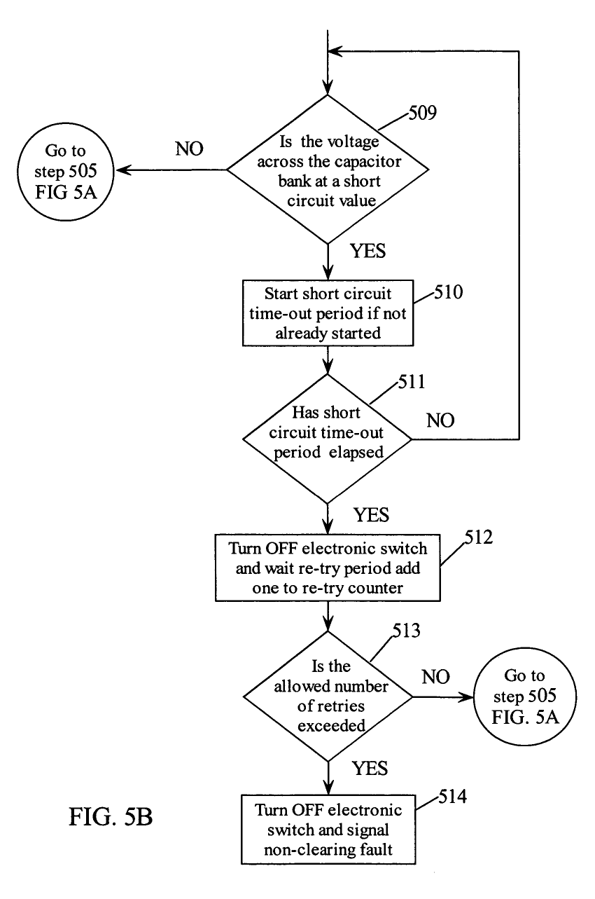

FIG. 5A is a flow diagram 500 of method steps used in another embodiment of the present invention. In step 501, a high voltage input is generated as a rectified DC voltage from a 50/60 Hz AC source. In step 502, an intermediate capacitor is charged with the high voltage input. In step 503, the intermediate capacitor is coupled to one node of an inductor with a high voltage electronic switch controlled by a first control signal. In step 504, the other node of the inductor is coupled to charge a capacitor bank with a controlled current by turning ON and OFF the electronic switch in response to the first control signal. In step 505, the high voltage output, the current from the high voltage input (input current), the charging current, and the output voltage across the capacitor bank are measured with sensors. In step 506, the first control signal is generated so that the electronic switch is turned ON and OFF thereby controlling the output current charging the capacitor bank so that it decreases as the output voltage across the capacitor bank increases. Likewise, as the output voltage across the capacitor bank decreases, the charging current to the capacitor bank increases. In step 507, a test is done to determine if the voltage across the capacitor bank has reached a maximum value. If the result of the test in step 507 is NO, then a branch is taken to step 509 of FIG. 5B continuing with additional steps. If the result of the test in step 507 is YES, then the capacitor bank may be discharged to provide pulsed power. In step 508, the capacitor bank is discharged in response to a second control signal that triggers a load coupled across the capacitor bank to switch to a low resistance. In one embodiment, the load is an arc initiated in a gap between two electrodes coupled across the capacitor bank. A branch is then taken to step 509 of FIG. 5B.

FIG. 5B has additional steps of flow diagram 500 beginning at step 509. In step 509, a test is done to determine if the voltage across the capacitor bank is at a short circuit value. This condition will exist after the capacitor bank is discharged to provide controlled pulsed power, discharged inadvertently, or because a short circuit fault exists. If the voltage across the capacitor bank is not a short circuit value, then a branch is taken back to step 505 in FIG. 5A where the high voltage input, the current from the high voltage input, the charging current, and the output voltage are measured. If the voltage across the capacitor bank is a short circuit value, then in step 510 a short circuit time-out period is started if one is not already in progress. This time-out period allows time for a virtual short that is the result of an initiated arc to clear (arc naturally extinguishes when capacitor bank energy is dissipated). In step 511, a test is done to determine if the time-out period has elapsed. If the result of the test in step 511 is NO, then a branch is taken back to step 509 to determine if the capacitor voltage is still a short circuit value. If the result of the test in step 511 is YES, then in step 512 the electronic switch is turned OFF and a wait is initiated before a retry is started. A retry counter keeps track of the number of retries. In step 513, a test is done to determine if the maximum number of retries has been exceeded. If the result of the test in step 513 is NO, then a branch is taken back to step 505 where input parameters (voltages and currents) are updated. If the result of the test in step 513 is YES, then the electronic switch is gated OFF and a non-clearing short circuit fault is signaled. The method of FIGS. 5A and 5B keeps the output power charging the capacitor bank substantially constant.

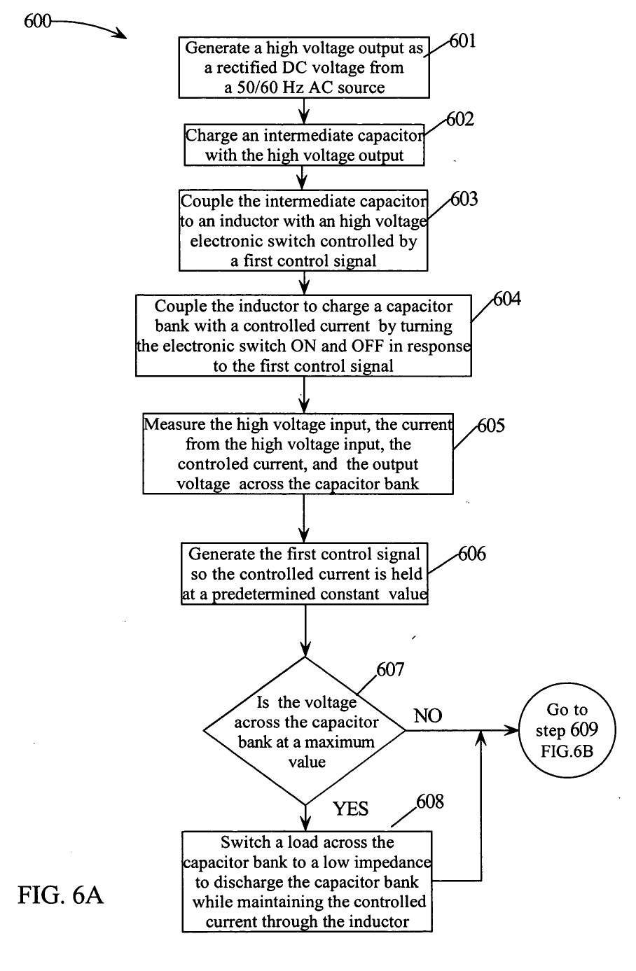

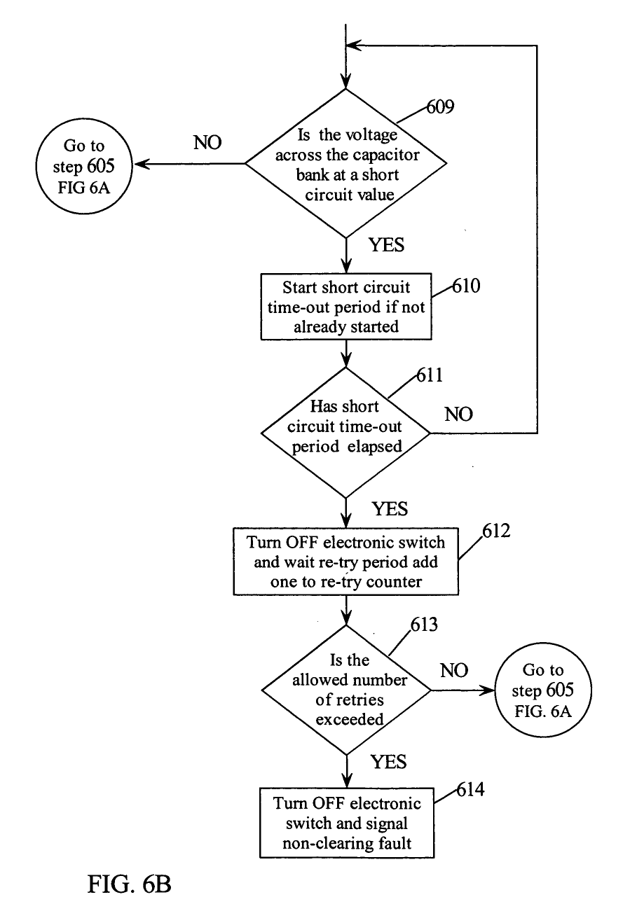

FIG. 6A is a flow diagram 600 of method steps used in another embodiment of the present invention. In step 601, a high voltage input is generated as a rectified DC voltage from a 50/60 Hz AC source. In step 602, an intermediate capacitor is charged with the high voltage input. In step 603, the intermediate capacitor is coupled to one node of an inductor with a high voltage electronic switch controlled by a first control signal. In step 604, the other node of the inductor is coupled to charge a capacitor bank with a controlled current by turning ON and OFF the electronic switch in response to the first control signal. In step 605, the high voltage output, the current from the high voltage input (input current), the charging current, and the output voltage across the capacitor bank are measured with sensors. In step 606, the first control signal is generated so that the electronic switch is turned ON and OFF thereby controlling the output current charging the capacitor bank substantially constant as the output voltage across the capacitor bank varies during charge and discharge. In step 607, a test is done to determine if the voltage across the capacitor bank has reached a maximum value. If the result of the test in step 607 is NO, then a branch is taken to step 609 of FIG. 6B continuing with additional steps. If the result of the test in step 607 is YES, then the capacitor bank may be discharged to provide pulsed power. In step 608, the capacitor bank is discharged in response to a second control signal that triggers a load coupled across the capacitor bank to switch to a low resistance. In one embodiment, the load is an arc initiated in a gap between two electrodes coupled across the capacitor bank. A branch is then taken to step 609 of FIG. 6B.

FIG. 6B has additional steps of flow diagram 600 beginning at step 609. In step 609, a test is done to determine if the voltage across the capacitor bank is at a short circuit value. This condition will exist after the capacitor bank is discharged to provide controlled pulsed power, discharged inadvertently, or because a short circuit fault exists. If the voltage across the capacitor bank is not a short circuit value, then a branch is taken back to step 605 in FIG. 6A where the high voltage input, the current from the high voltage input, the charging current, and the output voltage are measured. If the voltage across the capacitor bank is a short circuit value, then in step 610 a short circuit time-out period is started if one is not already in progress. This time-out period allows time for a virtual short that is the result of an initiated arc to clear (arc naturally extinguishes when capacitor bank energy is dissipated). In step 611, a test is done to determine if the time-out period has elapsed. If the result of the test in step 611 is NO, then a branch is taken back to step 609 to determine if the capacitor voltage is still a short circuit value. If the result of the test in step 611 is YES, then in step 612 the electronic switch is turned OFF and a wait is initiated before a retry is started. A retry counter keeps track of the number of retries. In step 613, a test is done to determine if the maximum number of retries has been exceeded. If the result of the test in step 613 is NO, then a branch is taken back to step 605 where input parameters (voltages and currents) are updated. If the result of the test in step 613 is YES, then the electronic switch is gated OFF and a non-clearing short circuit fault is signaled. The method of FIGS. 6A and 6B keeps the output current charging the capacitor bank substantially constant.

Although the present invention and its advantages have been described in detail, it should be understood that various changes, substitutions and alterations can be made herein without departing from the spirit and scope of the invention as defined by the appended claims.

What is claimed is:

1. A method of charging a capacitor bank providing pulsed power to a load coupled across the capacitor bank, comprising the steps of:
charging an intermediate capacitor, having first and second nodes, with a DC high voltage;
coupling and decoupling the first node of the intermediate capacitor to a first node of an inductor with an electronic switch that is turned ON and OFF in response to a first control signal, wherein a second node of the inductor is coupled to a first node of the capacitor bank, a second node of the capacitor bank is coupled to the second node of the intermediate capacitor, a first terminal of the load is coupled to the first node of the capacitor bank, and a second terminal of the load is coupled to the second node of the capacitor bank; and
generating the first control signal to vary turn ON and OFF times of the electronic switch to generate a controlled current through the inductor while a voltage across the capacitor bank varies over a positive and negative voltage range during charging and discharging of the capacitor bank.

2. The method of claim 1, wherein the capacitor bank is discharged by switching the load to a low resistance while the controlled current through the inductor is maintained.

3. The method of claim 1, wherein the DC high voltage is provided by an AC step-up transformer having a primary winding coupled to a 50/60 Hz AC line voltage and a secondary winding generating a high voltage AC output and a full wave rectifier circuit receiving the high voltage AC output and generating the DC high voltage.

4. The method of claim 1, wherein the first control signal is generated in response to an input current provided by the DC high voltage.

5. The method of claim 1, wherein the first control signal is generated in response to the voltage across the capacitor bank and the controlled current through the inductor.

6. The method of claim 1, wherein an average value of the controlled current is maintained at a substantially constant value.

7. The method of claim 4, wherein the controlled current through the inductor is varied to keep a product of the input current and the DC high voltage potential substantially constant.

8. The method of claim 5, wherein an average value of the controlled current increases as the voltage across the capacitor bank decreases and the average value of the controlled current decreases as the voltage across the capacitor bank increases.

9. The method of claim 1, wherein the electronic switch is turned ON when the first control signal has a first logic state and is turned OFF when the first control signal has a second logic state.

10. The method of claim 9, wherein the first control signal switches to the first logic state when a current sense signal indicates the controlled current through the inductor is less than a minimum current value and the voltage across the capacitor bank is less than a maximum voltage value, and the first control signal switches to the second logic state when the current sense signal indicates the controlled current through the inductor is greater than a maximum current value or the output voltage across the capacitor bank is greater than the maximum voltage value.

11. A power system for charging a capacitor bank providing pulsed power to a load having a first and second terminal comprising:
a step-up isolation transformer having a primary winding coupled to a 50/60 Hz AC line voltage and a secondary winding generating a high voltage AC output;
a rectifying circuit for rectifying the high voltage AC output across the secondary winding to generate a high voltage DC potential;
circuitry for charging an intermediate capacitor to the high DC voltage potential;
an electronic switch for coupling and decoupling a first node of the intermediate capacitor to a first node of an inductor in response to a first control signal, wherein a second node of the inductor is coupled to a first node of the capacitor bank, a second node of the capacitor bank is coupled to a second node of the intermediate capacitor, the first terminal of the load is coupled to the first node of the capacitor bank, and the second terminal of the load is coupled to the second node of the capacitor bank; and
a switching regulator controller generating the first control signal to vary the turn ON and OFF times of the electronic switch to generate a controlled current through the inductor while the voltage across the capacitor bank varies over a positive and negative voltage range during charging and discharging of the capacitor bank.

12. The power system of claim 11, wherein the capacitor bank is discharged by switching the load to a low resistance while the controlled current through the inductor is maintained.

13. The power system of claim 11, wherein the first control signal is generated in response to an input current provided by the DC high voltage potential.

14. The power system of claim 11, wherein the first control signal is generated in response to the voltage across the capacitor bank and the controlled current through the inductor.

15. The power system of claim 11, wherein an average value of the controlled current through the inductor is maintained at a substantially constant value.

16. The power system of claim 13, wherein an average value of the controlled current level through the inductor is varied to keep a product of the input current and the DC high voltage potential substantially constant.

17. The power system of claim 14, wherein an average value of the controlled current increases as the voltage across the capacitor bank decreases and the average value of the controlled current decreases as the voltage across the capacitor bank increases.

18. The power system of claim 11, wherein the electronic switch is turned ON when the first control signal has a first logic state and is turned OFF when the first control signal has a second logic state.

19. The power system of claim 18, wherein the first control signal switches to the first logic state when a current sense signal indicates the controlled current through the inductor is less than a minimum current value and the voltage across the capacitor bank is less than a maximum voltage value, and the first control signal switches to the second logic state when the current sense signal indicates the controlled current through the inductor is greater than a maximum current value or the output voltage across the capacitor bank is greater than the maximum voltage value.

20. The power system of claim 14, wherein the controlled current through the inductor is varied inversely with the voltage across the capacitor bank thereby controlling power surges on the 50/60 Hz AC line voltage at the primary winding.

21. The power system of claim 13, wherein the controlled current through the inductor is varied to keep input power provided by the 50/60 Hz AC line voltage substantially constant thereby controlling power surges on the 50/60 Hz AC line voltage at the primary winding.

22. The power system of claim 12, wherein the load is switched to the low resistance in response to a second control signal.

23. The power system of claim 22, wherein the load is an arc initiated in a gap between a first and second electrode coupled across the capacitor bank.

24. The power system of claim 23, wherein the arc is initiated between the first and second electrode in response the second control signal or spontaneously by conditions in the gap and the voltage across the capacitor bank.

25. A power system for charging a capacitor bank providing pulsed power to a load comprising:
a DC high voltage source;
an intermediate capacitor coupled to the DC high voltage source in a manner so that it is energized by the DC high voltage source;
a capacitor bank adaptable for coupling to the load;
an inductor coupled in series with an electronic switch between the intermediate capacitor and the capacitor bank; and
a switching regulator for controlling ON and OFF times of the electronic switch to generate a controlled current through the inductor while a voltage across the capacitor bank varies over a positive and negative voltage range during charging and discharging of the capacitor bank.
